(19) United States
(12) Patent Application Publication
(10) Pub. No.: US 2024/0399603 A1
(43) Pub. Date: Dec. 5, 2024

(54) METHOD AND SYSTEM FOR ENERGY CELL DISASSEMBLY

(71) Applicant: GM GLOBAL TECHNOLOGY OPERATIONS LLC, Detroit, MI (US)

(72) Inventors: William Osad, Macomb, MI (US); Ryan C. Sekol, Grosse Pointe Woods, MI (US); Nicholas P. Irish, Commerce, MI (US); Michael P. Balogh, Novi, MI (US); Erik B. Golm, Sterling Heights, MI (US)

(73) Assignee: GM GLOBAL TECHNOLOGY OPERATIONS LLC, Detroit, MI (US)

(21) Appl. No.: 18/327,357

(22) Filed: Jun. 1, 2023

(51) Int. Cl. B26D 7/02; B26D 1/00; B26D 1/02; H01M 10/42

(52) U.S. Cl. CPC B26D 7/02; B26D 1/0006; B26D 1/02; H01M 10/42; B26D 2001/004

(57) ABSTRACT

A system for disassembling a energy cell having a case includes a energy cell securement device arranged on a moveable table; and a cutting tool. The energy cell securement device is configured to fixedly secure the energy cell with a portion of the case exposed proximal to the cutting tool. The moveable table is configured to convey the energy cell securement device such that the cutting tool cleaves the portion of the case of the energy cell.

### INTRODUCTION

Engineers, technicians, and others may want or need to disassemble An electrochemical energy cell, such as a battery, for purposes of manufacturing quality assurance, warranty analysis, or other reasons. Known disassembly practices involve employing a handheld rotary cutting tool to cut and remove an outer case of a battery cell. Attendant risks may include inconsistent cutting depths, damaged internal components, scattered cutting debris, and electrolyte leakage, among others.

### SUMMARY

There is a need for a system and associated method to consistently disassemble energy storage devices (hereafter “energy cell” or “energy cells”), e.g., lithium-ion electrochemical battery cells. There is a need to be able to remove an outer shell from a energy cell in a manner that eliminates or minimizes harm to internal components of the energy cell, and eliminates or minimizes debris associated therewith.

The concepts described herein provide one or more of a device, a system, and a method that is arranged to clamp a energy cell in place, position a cutting tool in a fixed position, and employ a linear motion or a rotational motion to convey the energy cell across the cutting tool in a controlled manner. This may include setting a cutting depth that minimizes or eliminates damage to internal components of the energy cell.

An aspect of the disclosure may include a system for disassembling a energy cell having a case, including a energy cell securement device arranged on a moveable table; and a cutting tool that is held stationary. The energy cell securement device is configured to fixedly secure the energy cell with a portion of the case exposed proximal to the cutting tool. The moveable table is configured to convey the energy cell securement device such that the cutting tool cleaves the portion of the case of the energy cell.

Another aspect of the disclosure may include the carriage being configured to translate the energy cell securement device such that the cutting tool is positioned to cleave a longitudinal slit into the case of the energy cell.

Another aspect of the disclosure may include the carriage being arranged on a table, wherein the table includes a base and a worm gear, and wherein the carriage is translatable on the base to translate the energy cell securement device in response to a rotation of the worm gear.

Another aspect of the disclosure may include the carriage being translatable on the base to translate the energy cell securement device in response to the rotation of the worm gear such that the cutting tool is positioned to cleave a longitudinal slit in the portion of the case of the energy cell.

Another aspect of the disclosure may include the carriage being arranged on a table, wherein the table includes a base and a worm gear, and wherein the carriage is rotatable on the base to rotate the energy cell securement device in response to a rotation of the worm gear.

Another aspect of the disclosure may include the carriage being rotatable on the base to rotate the energy cell securement device in response to the rotation of the worm gear such that the cutting tool is positioned to cleave a peripheral slit in the portion of the case of the energy cell.

Another aspect of the disclosure may include the energy cell including a cylindrically shaped case having a first end; wherein the table is configured to rotate the energy cell securement device such that the cutting tool is positioned to cleave the peripheral slit in the cylindrically shaped case of the energy cell proximal to the first end.

Another aspect of the disclosure may include the cutting tool being a wedge-shaped chisel.

Another aspect of the disclosure may include the cutting tool being a snipping tool.

Another aspect of the disclosure may include the cutting tool being a fixed saw blade.

Another aspect of the disclosure may include the energy cell securement device being a clamping vise.

Another aspect of the disclosure may include the clamping vise including opposed moveable jaws, wherein faces of the opposed moveable jaws are semi-cylindrically shaped.

Another aspect of the disclosure may include a method for disassembling a energy cell having an case that includes securing, via a energy cell securement device, the energy cell to a moveable table, wherein a portion of the case is exposed; and moving a portion of the moveable table proximal to a cutting tool such that the case of the energy cell interferes with the cutting tool; wherein the moveable table is configured to convey the energy cell securement device such that the cutting tool cleaves the portion of the case.

Another aspect of the disclosure may include a system for disassembling a energy cell having a case that includes a energy cell securement device arranged on a table, wherein the table includes a base section, an elevating portion, an elevation carriage, a rotatable carriage, and a rotational actuator; and a cutting tool. The energy cell securement device is configured to fixedly secure a energy cell with a portion of a case thereof being exposed, and the cutting tool is arranged to contact the outer metallic shell. The elevation carriage is arranged to move vertically in relation to the base section to vertically lift the energy cell securement device in response to a lifting action by the elevating portion, and is configured to convey the energy cell securement device in relation to the cutting tool such that the cutting tool is positioned to cleave a longitudinal slit in the outer metallic shell of the energy cell. The rotatable carriage is arranged to rotate the energy cell securement device in response to a rotating action from the rotational actuator; and is configured to convey the energy cell securement device in relation to the cutting tool such that the cutting tool is positioned to cleave a peripheral slit in the outer metallic shell of the energy cell.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIGS. 1A and 1B schematically illustrate an embodiment of a cylindrically shaped rechargeable battery (battery), in accordance with the disclosure.

FIG. 2 schematically illustrates an embodiment of a energy cell disassembly tool, in accordance with the disclosure.

FIG. 3 schematically illustrates another embodiment of a energy cell disassembly tool, in accordance with the disclosure.

FIG. 4 schematically illustrates another embodiment of a energy cell disassembly tool, in accordance with the disclosure.

FIG. 5 schematically illustrates another embodiment of a energy cell disassembly tool, in accordance with the disclosure.

FIG. 6 schematically illustrates elements related to another embodiment of a energy cell disassembly tool, in accordance with the disclosure.

FIG. 7 schematically illustrates another embodiment of a energy cell disassembly tool, in accordance with the disclosure.

FIG. 8 schematically illustrates another embodiment of a energy cell disassembly tool, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments may be practiced without some of these details. Moreover, for the purpose of clarity, certain technical material that is understood in the related art has not been described in detail to avoid unnecessarily obscuring the disclosure.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” For example, “optimal vehicle routes” may include one or more optimal vehicle routes. Moreover, words of approximation such as “about,” “almost,” “substantially,” “generally,” “approximately,” etc., may be used herein in the sense of “at, near, or nearly at,” or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

The following detailed description is merely illustrative in nature and is not intended to limit the application and uses. Throughout the drawings, corresponding reference numerals indicate like or corresponding parts and features. Furthermore, there is no intention to be bound by any expressed or implied theory presented herein. Furthermore, the disclosure, as illustrated and described herein, may be practiced in the absence of an element that is not specifically disclosed herein.

For purposes of convenience and clarity, directional terms such as top, bottom, left, right, up, over, above, below, beneath, rear, and front, and similar expressions are employed for description, and are not to be construed to limit the scope of the disclosure. The use of ordinals such as first, second and third does not imply a ranked sense of order, but rather may distinguish between multiple instances of an act or structure.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

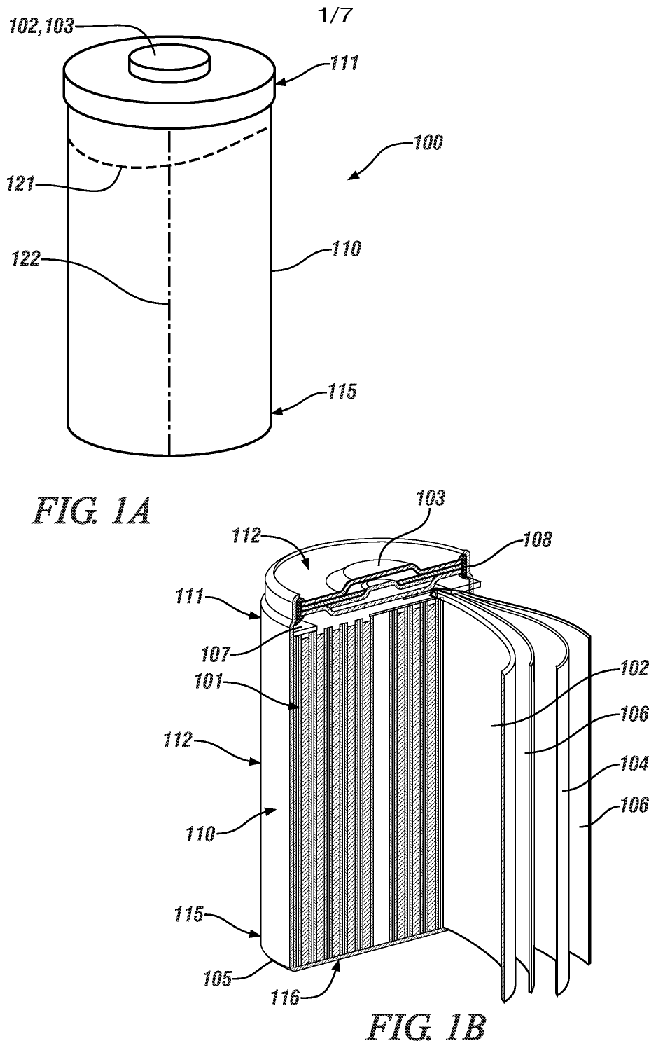

Referring to the drawings, wherein like reference numerals correspond to like or similar components throughout the several Figures, FIGS. 1A and 1B, consistent with embodiments disclosed herein, schematically illustrate an embodiment of a cylindrically shaped rechargeable electrical energy storage device (cell) 100.

In one embodiment, the energy cell 100 is a rechargeable lithium-ion electrochemical battery that is composed of an internal portion 101 that is disposed in an outer shell or case 110. The internal portion 101 includes first and second paired electrodes 102, 103, respectively, that are arranged in a stack and rolled into a cylindrical shape that is inserted into the case 110 and sealed therein with a top portion 112. Alternatively, the energy cell 100 is a supercapacitor, or another electrical energy storage device.

In one embodiment, the case 110 is a hollow cylindrical tube that is open on a top end 111 and closed on a bottom end 115. In one embodiment, the case 110 is fabricated from metal, e.g., aluminum, aluminum alloy, steel, steel alloy, or another metal. Alternatively, the case 110 is fabricated from a polymeric material.

As illustrated with reference to FIG. 1B, the internal portion 101 of the energy cell 100 includes a positive electrode or cathode 102 that electrically connects to a first terminal 103, and a negative electrode or anode 104 that electrically connects to a second terminal 105. The cathode 102 is separated from the anode 104 by a separator 106, which may also encompass an outer portion thereof. An insulation plate 107 may be disposed between an upper portion of the internal portion 101 and a top portion 112 of the case 110. Another insulation plate 107 may be disposed between a lower portion of the internal portion 101 and a base 116 of the case 110. A vent 108 may be arranged in the top portion 112 to enable outgassing. The top portion 112 of the case 110 may be electrically connected to and function as the first terminal 103. The base 116 and/or a cylindrical body 114 of the case 110 may be electrically connected to and function as the second terminal 105. Examples of a longitudinal slit 121 and a peripheral slit 122 are illustrated.

The concepts described herein provide a energy cell disassembly tool that may be employed to secure an embodiment of the energy cell 100, and employ a cutting tool to cleave the case 110 along a longitudinal portion thereof, and/or cleave the case 110 around a periphery portion near the top portion 112 and/or the base 116 without interfering with or otherwise damaging the internal portion 101 of the energy cell 100.

As employed herein, the term “cleave” and related terms refer to cutting, severing, or splitting a device apart with a sharp instrument, including conveying a portion of a device across a sharp instrument that is being held in a stationary position. Furthermore, the cutting or splitting of a device apart with a sharp instrument is accomplished with minimal or no chipping of the material of the device being split, which minimizes associated debris.

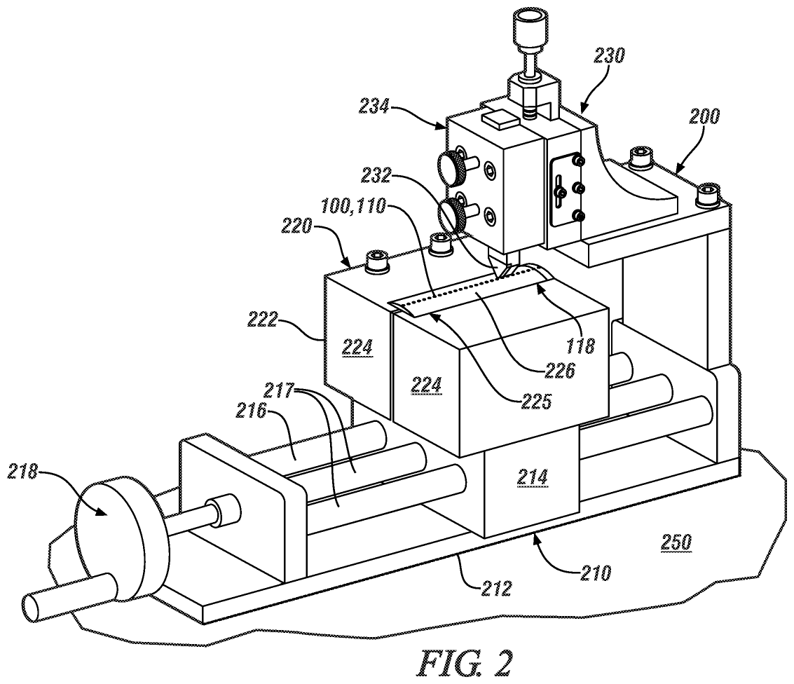

Referring now to FIG. 2, with continued reference to an embodiment of the energy cell 100 of FIGS. 1A and 1B, an embodiment of a energy cell disassembly tool 200 is described. The energy cell disassembly tool 200 is disposed on a surface 250, and includes a table 210, a energy cell securement device 220, and a cutting tool assembly 230.

The table 210 and the energy cell securement device 220 are arranged to employ the cutting tool assembly 230 to cleave a portion of the case 110 of the energy cell 100 without interfering with or otherwise damaging the internal portion 101 of the energy cell 100.

The energy cell securement device 220 includes an adjustable clamping device 222 arranged with opposed sides 224 that define a battery-shaped space 225 that defines an open longitudinal area 226. In this embodiment, the battery-shaped space 225 is a partial cylindrical shape, and the open longitudinal area 226 defines a rectangular space. When an embodiment of the energy cell 100 having a cylindrical shape is placed into the battery-shaped space 225, a rectangularly-shaped longitudinal portion 118 of the body 114 of the case 110 is exposed.

In one embodiment, the opposed sides 224 of the adjustable clamping device 222 have semi-cylindrical shapes. The opposed sides 224 of the adjustable clamping device 222 are moveable to exert a compressive force on the energy cell 100 to secure the energy cell 100 into a desired position. The energy cell securement device 220 is arranged on a slidable carriage 214 of the table 210, and moves therewith.

The table 210 includes a base portion 212, slidable carriage 214, a threaded rod 216, alignment rods 217, and a rotational actuator 218.

The base portion 212 rests on the surface 250. The slidable carriage 214 rests on the base portion 212. The slidable carriage 214 includes a plurality of cylindrical apertures arranged in parallel. In one embodiment, one of the apertures is threaded and is able to meshingly engage the threaded rod 216. The other apertures accommodate the alignment rods 217. The rotational actuator 218 is coupled to the threaded rod 216. When the rotational actuator 218 rotates the threaded rod 216, the slidable carriage 214 is conveyed and traverses linearly along the base portion 212 due to the meshing of the threaded rod 216 within the threaded aperture of the slidable carriage 214. This action causes the energy cell securement device 220 arranged on the table 210 to be conveyed on the base portion 212 in alignment with the threaded rod 216.

The cutting tool assembly 230 includes a cutting tool 232 that is mounted on and secured to the base portion 212 of the table 210 employing a mounting and adjustment element 234.

The cutting tool 232 is a wedge-shaped chisel in one embodiment. Alternatively, the cutting tool 232 is a snipping tool in one embodiment. Alternatively, the cutting tool 232 is a multi-toothed saw blade in one embodiment. The function of the cutting tool 232 is to cleave the portion of the case 110 of the energy cell 100 without interfering with or damaging the internal portion 101 of the energy cell when the energy cell 100 is conveyed therepast.

The mounting and adjustment element 234 is configured to position the cutting tool 232 in a manner that is proximal to the open longitudinal area 226 of the adjustable clamping device 222 of the energy cell securement device 220. This arrangement enables the cutting tool 232 to engage the exposed longitudinal portion 118 of the body 114 of the case 110 of the energy cell 100 at a depth that does not interfere with the internal portion 101 of the energy cell 100 when the energy cell 100 is disposed in the energy cell securement device 220.

The rotational actuator 218 is a manually operated mechanical device in one embodiment. Alternatively, the rotational actuator 218 is an electrical motor in one embodiment.

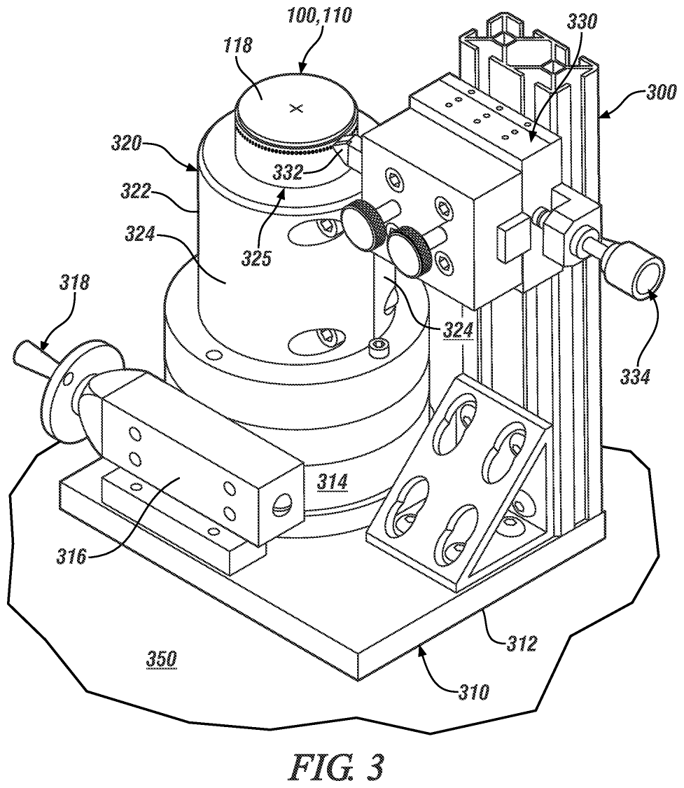

Referring now to FIG. 3, with continued reference to an embodiment of the energy cell 100 of FIGS. 1A and 1B, another embodiment of a energy cell disassembly tool 300 is described. The energy cell disassembly tool 300 is disposed on a surface 350, and includes a table 310, a energy cell securement device 320, and a cutting tool 330.

The table 310 and the energy cell securement device 320 are arranged to employ the cutting tool assembly 330 to cleave a portion of the case 110 of the energy cell 100 without interfering with or otherwise damaging the internal portion 101 of the energy cell 100.

The energy cell securement device 320 includes an adjustable clamping device 322 arranged with opposed sides 324 that define a battery-shaped space 325 that is arranged to partially encompass an embodiment of the energy cell 100. In this embodiment, the battery-shaped space 325 is cylindrical, and the adjustable clamping device 322 accommodates a lower or bottom portion of the energy cell 100. When an embodiment of the energy cell 100 having a cylindrical shape is placed into the battery-shaped space 325, an upper portion of the body 114 of the case 110 of the energy cell 100 is exposed.

In one embodiment, the opposed sides 324 of the adjustable clamping device 322 have semi-cylindrical shapes. The opposed sides 324 of the adjustable clamping device 322 are moveable to exert a compressive force on the energy cell 100 to secure the energy cell 100 into a desired position. The energy cell securement device 320 is arranged on a rotatable carriage 314 of the table 310, and moves therewith.

The table 310 includes a base portion 312, rotatable carriage 314, and a rotational actuator 318.

The base portion 312 rests on the surface 350. The rotatable carriage 314 rests on the base portion 312 and includes an annular spur gear 316. The rotational actuator 318 is coupled to the annular spur gear 316. When the rotational actuator 318 rotates the annular spur gear 316, the rotatable carriage 314 is rotated. This action causes the energy cell securement device 320 arranged on the table 310 to rotate.

The cutting tool assembly 330 includes a cutting tool 332 that is mounted on and secured to the base portion 312 of the table 310 employing a mounting and adjustment element 334.

The cutting tool 332 is a wedge-shaped chisel in one embodiment. Alternatively, the cutting tool 332 is a snipping tool in one embodiment. Alternatively, the cutting tool 332 is a multi-toothed saw blade in one embodiment. The function of the cutting tool 332 is to cleave the portion of the case 110 of the energy cell 100 without interfering with or damaging an internal portion of the energy cell when the energy cell 100 is conveyed therepast.

The mounting and adjustment element 334 is configured to position the cutting tool 332 in a manner that is proximal to the upper portion of the body 114 of the case 110 of the energy cell 100 when placed in the energy cell securement device 320. This arrangement enables the cutting tool 332 to engage the exposed upper portion of the body 114 of the case 110 of the energy cell 100 when the energy cell 100 is disposed in the energy cell securement device 320.

The rotational actuator 318 is a manually operated mechanical device in one embodiment. Alternatively, the rotational actuator 318 is an electrical motor in one embodiment.

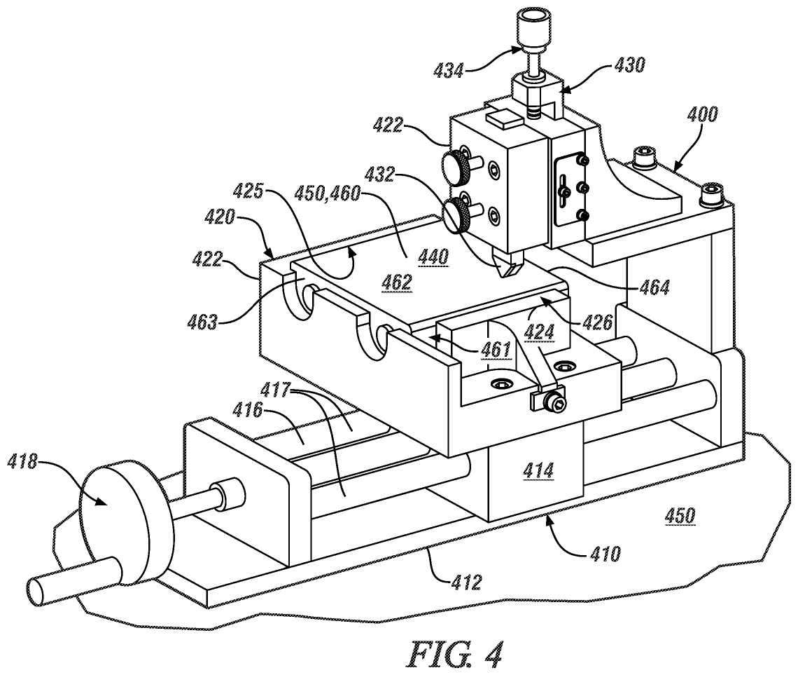

Referring now to FIG. 4, an embodiment of a energy cell disassembly tool 400 for disassembling a battery 450 is described. The energy cell disassembly tool 400 is disposed on a surface 440, and includes a table 410, a energy cell securement device 420, and a cutting tool 430.

The battery 450 is arranged as a prismatic battery and includes a case 460 that houses an internal portion. Although not illustrated, the internal portion of the battery 450 is analogous in structure and components to the internal portion 101 of the energy cell 100 that is described with reference to FIG. 1B. The case 460 of the battery 450 has a prismatic configuration in this embodiment, including end portions 461, side portions 462, top portion 463, and bottom portion 464.

The table 410 and the energy cell securement device 420 are arranged to employ the cutting tool assembly 430 to cleave a portion of the case 460 of the battery 450 without interfering with or otherwise damaging the internal portion 101 of the energy cell 100.

The energy cell securement device 420 includes an adjustable clamping device 422 arranged with opposed sides 424 that define a prismatic battery-shaped space 425 that defines an open longitudinal area 426. In this embodiment, the battery-shaped space 425 is a rectangular shape, and the open longitudinal area 426 defines a rectangular space. When an embodiment of the battery 450 is placed into the battery-shaped space 425, a rectangularly-shaped portion of the case 460 is exposed.

In one embodiment, the opposed sides 424 of the adjustable clamping device 422 are moveable to exert a compressive force on the battery 450 to secure the battery 450 into a desired position. The energy cell securement device 420 is arranged on a slidable carriage 414 of the table 410 and moves therewith.

The table 410 includes a base portion 412, slidable carriage 414, a threaded rod 416, alignment rods 417, and a rotational actuator 418.

The base portion 412 rests on the surface 450. The slidable carriage 414 rests on the base portion 412. The slidable carriage 414 includes a plurality of cylindrical apertures arranged in parallel. In one embodiment, one of the apertures is threaded and is able to meshingly engage the threaded rod 416. The other apertures accommodate the alignment rods 417. The rotational actuator 418 is coupled to the threaded rod 416. When the rotational actuator 418 rotates the threaded rod 416, the slidable carriage 414 is conveyed and traverses linearly along the base portion 412 due to the meshing of the threaded rod 416 within the threaded aperture of the slidable carriage 414. This action causes the energy cell securement device 420 arranged on the table 410 to be conveyed on the base portion 412 in alignment with the threaded rod 416.

The cutting tool assembly 430 includes a cutting tool 432 that is mounted on and secured to the base portion 412 of the table 410 employing a mounting and adjustment element 434.

The cutting tool 432 is a wedge-shaped chisel in one embodiment. Alternatively, the cutting tool 432 is a snipping tool in one embodiment. Alternatively, the cutting tool 432 is a multi-toothed saw blade in one embodiment. The function of the cutting tool 432 is to cleave the portion of the case 110 of the energy cell 450 without interfering with or damaging an internal portion of the energy cell when the energy cell 450 is conveyed therepast.

The mounting and adjustment element 434 is configured to position the cutting tool 432 in a manner that is proximal to the open longitudinal area 426 of the adjustable clamping device 422 of the energy cell securement device 420. This arrangement enables the cutting tool 432 to engage the exposed longitudinal portion 118 of the body 114 of the case 460 of the battery 450 when the battery 450 is disposed in the energy cell securement device 420.

The rotational actuator 418 is a manually operated mechanical device in one embodiment. Alternatively, the rotational actuator 418 is an electrical motor in one embodiment.

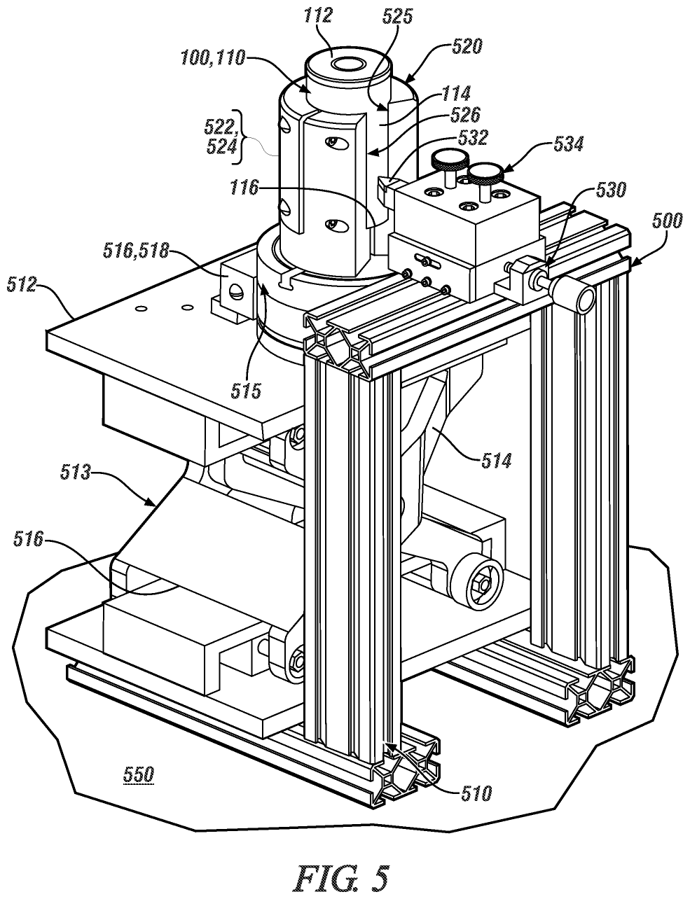

Referring now to FIG. 5, with continued reference to an embodiment of the energy cell 100 of FIGS. 1A and 1B, another embodiment of a energy cell disassembly tool 500 is described. The energy cell disassembly tool 500 is disposed on a surface 550, and includes a table 510, a energy cell securement device 520, and a cutting tool 530.

The table 510 and the energy cell securement device 520 are arranged to employ the cutting tool assembly 530 to cleave a portion of the case 110 of the energy cell 100 without interfering with or otherwise damaging the internal portion 101 of the energy cell 100.

The energy cell securement device 520 includes an adjustable clamping device 522 arranged with opposed sides 524 that define a battery-shaped space 525 that includes an open longitudinal area 526. In this embodiment, the battery-shaped space 525 is a partial cylindrical shape, and the open longitudinal area 526 defines a rectangular space. Furthermore, the battery-shaped space 525 is truncated such that the adjustable clamping device 522 accommodates a lower or bottom portion of the energy cell 100. When an embodiment of the energy cell 100 having a cylindrical shape is placed into the battery-shaped space 525, an upper portion of the body 114 of the case 110 of the energy cell 100 is exposed, and a rectangularly-shaped longitudinal portion 118 of the body 114 of the case 110 is exposed in the open longitudinal area 526.

In one embodiment, the opposed sides 524 of the adjustable clamping device 522 have semi-cylindrical shapes. The opposed sides 524 of the adjustable clamping device 522 are moveable to exert a compressive force on the energy cell 100 to secure the energy cell 100 into a desired position.

The energy cell securement device 520 is arranged on the table 510 and moves therewith.

The table 510 includes a base section 512, an elevating portion 513, an elevation carriage 514, a rotatable carriage 515, and a rotational actuator 518. The elevation carriage 514 moves vertically in relation to the base section 512 to vertically lift the energy cell securement device 520 in response to a lifting action by the elevating portion 513. The elevating portion 513 may be a scissor jack in one embodiment, or another vertical lifting device.

The rotatable carriage 515 includes an annular spur gear 516 in one embodiment. The rotatable carriage 515 rotates the energy cell securement device 520 on the table 510 in response to a rotating action from the rotational actuator 518.

The cutting tool assembly 530 includes a cutting tool 532 that is mounted on and secured to the base portion 512 of the table 510 employing a mounting and adjustment element 534.

The cutting tool 532 is a wedge-shaped chisel in one embodiment. Alternatively, the cutting tool 532 is a snipping tool in one embodiment. Alternatively, the cutting tool 532 is a multi-toothed saw blade in one embodiment. The function of the cutting tool 532 is to cleave the portion of the case 110 of the energy cell 100 without interfering with or damaging an internal portion of the energy cell when the energy cell 100 is conveyed therepast.

The mounting and adjustment element 534 is configured to position the cutting tool 532 in a manner that is proximal to the open longitudinal area 526 of the adjustable clamping device 522 of the energy cell securement device 520. This arrangement enables the cutting tool 532 to engage the exposed longitudinal portion 118 of the body 114 of the case 110 of the energy cell 100 when the energy cell 100 is disposed in the energy cell securement device 520 in a first cleaving action, and also enables the cutting tool 532 to engage the upper portion of the body 114 of the case 110 of the energy cell 100 during rotation by the rotational actuator 518.

The rotational actuator 518 is a manually operated mechanical device in one embodiment. Alternatively, the rotational actuator 518 is an electrical motor in one embodiment.

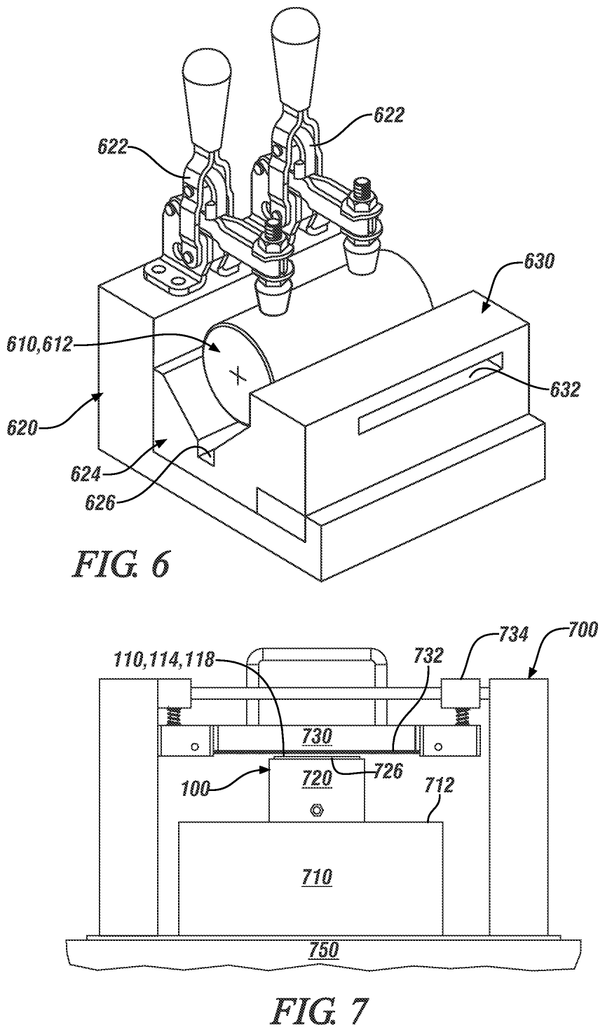

FIG. 6 schematically illustrates another embodiment of the energy cell securement device 620, which includes a v-block 624 and one or multiple adjustable toggle clamps 622. A cylindrical battery 610 having an outer case 612 may be placed longitudinally along a vertex 626 of the v-block 624 and secured by the toggle clamps 622. The adjustability of the toggle clamps 622 facilitates accommodating a range of battery diameters.

In one embodiment, the energy cell securement device 620 may be employed in the energy cell disassembly tool 200 described with reference to FIG. 2.

In one embodiment, and as shown, the energy cell securement device 620 includes a side block 630 having a slot 632 arranged therein that is parallel to the vertex 626. An open end of the slot 632 is adjacent to the outer case 612 of the cylindrical battery 610. The slot 632 may be employed as a guide for a cutting tool to cleave a longitudinal slit in the outer case 612.

Referring now to FIG. 7, with continued reference to an embodiment of the energy cell 100 of FIGS. 1A and 1B, another embodiment of the energy cell disassembly tool 700 is described. The energy cell disassembly tool 700 is disposed on a surface 750, and includes a table 710, a energy cell securement device 720, and a cutting tool assembly 730.

The table 710 and the energy cell securement device 720 are arranged to employ the cutting tool assembly 730 to cleave a portion of the case 110 of the energy cell 100 without interfering with or otherwise damaging the internal portion of the energy cell 100.

The energy cell securement device 720 is analogous to the energy cell securement device 220 that is described with reference to FIG. 2, and defines an open longitudinal area 726. When an embodiment of the energy cell 100 having a cylindrical shape is placed into the energy cell securement device 720, a rectangularly-shaped longitudinal portion 118 of the body 114 of the case 110 of the energy cell 100 is exposed. The table 710 rests on the surface 750.

The cutting tool assembly 730 includes a cutting tool 732 that is mounted on and secured to the base portion 712 of the table 710 employing a mounting and adjustment element 734.

The cutting tool 732 is a multi-toothed saw blade in one embodiment. The function of the cutting tool 732 is to cleave the portion of the case 110 of the energy cell 100 without interfering with or damaging an internal portion of the energy cell when the energy cell 100 is conveyed therepast.

The cutting tool 732 is positioned in a manner that is proximal to the open longitudinal area 726 of the energy cell securement device 720. This arrangement enables the cutting tool 732 to engage the exposed longitudinal portion 118 of the body 114 of the case 110 of the energy cell 100 when the energy cell 100 is disposed in the energy cell securement device 720.

In one embodiment, the portion of the longitudinal portion 118 of the body 114 of the case 110 of the energy cell 100 is cleaved by moving the cutting tool 732 over the energy cell 100.

In one embodiment, the portion of the longitudinal portion 118 of the body 114 of the case 110 of the energy cell 100 is cleaved by repetitively moving the cutting tool 732 in a reciprocating motion over the energy cell 100.

In one embodiment, the portion of the longitudinal portion 118 of the body 114 of the case 110 of the energy cell 100 is cleaved by moving the energy cell securement device 720 under the cutting tool 732.

In one embodiment, the portion of the longitudinal portion 118 of the body 114 of the case 110 of the energy cell 100 is cleaved by repetitively moving the energy cell securement device 720 under the cutting tool 732 in a reciprocating motion.

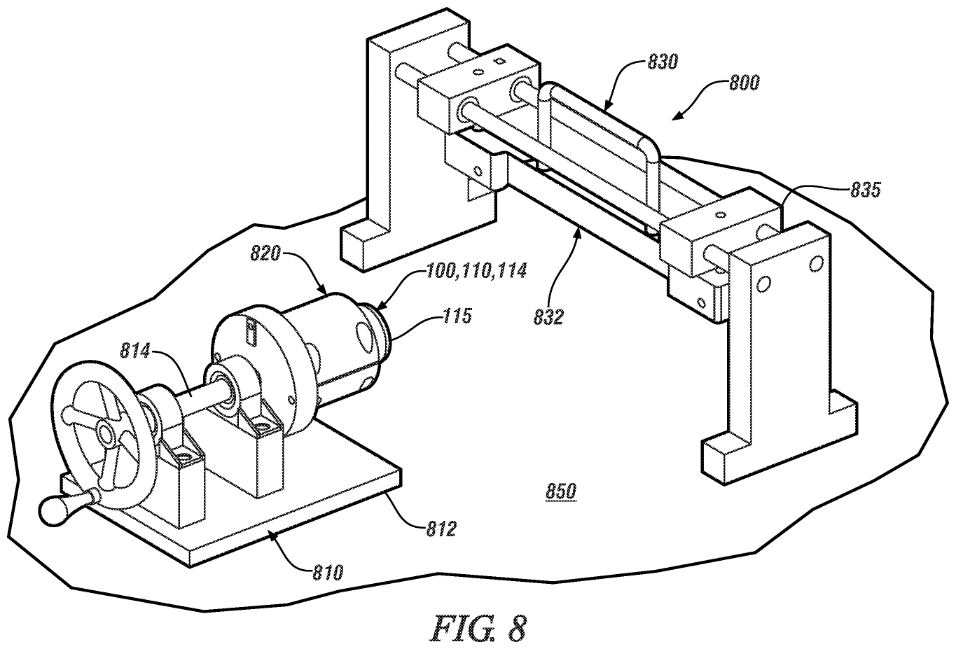

Referring now to FIG. 8, with continued reference to an embodiment of the energy cell 100 of FIGS. 1A and 1B, another embodiment of the energy cell disassembly tool 800 is described. The energy cell disassembly tool 800 is disposed on a surface 850, and includes a table 810, a energy cell securement device 820, and a cutting tool assembly 830.

The table 810 and the energy cell securement device 820 are arranged to employ the cutting tool assembly 830 to cleave a portion of the case 110 of the energy cell 100 without interfering with or otherwise damaging the internal portion of the energy cell 100.

The energy cell securement device 820 is analogous to the energy cell securement device 320 that is described with reference to FIG. 2 and is mounted on a rotatable shaft 814 to permit rotation of the energy cell 100 about its longitudinal axis. When an embodiment of the energy cell 100 having a cylindrical shape is placed therein, an upper portion (or lower portion) of the body 114 of the case 110 of the energy cell 100 is exposed, including a battery end 115. In one embodiment, the battery end is the top end. In one embodiment, the battery end is the bottom end.

The table 810 rests on the surface 850.

The cutting tool assembly 830 includes a cutting tool 832 that is mounted on and secured to the base portion 812 of the table 810 employing a mounting and adjustment element 835. The cutting tool 832 is a multi-toothed saw blade in one embodiment. The function of the cutting tool 832 is to cleave the end 115 of the body 114 of the case 110 of the energy cell 100 without interfering with or damaging an internal portion of the energy cell when the energy cell 100 is conveyed therepast.

The cutting tool 832 is positioned in a manner that is proximal to the end 115 of the body 114 of the case 110 of the energy cell 100. This arrangement enables the cutting tool 832 to engage the end 115 of the case 110 of the energy cell 100 when the energy cell 100 is disposed in the energy cell securement device 820.

In one embodiment, the end 115 of the body 114 of the case 110 of the energy cell 100 is cleaved by moving the cutting tool 832 over the energy cell 100.

In one embodiment, the end 115 of the body 114 of the case 110 of the energy cell 100 is cleaved by repetitively moving the cutting tool 832 in a reciprocating motion over the energy cell 100.

In one embodiment, the end 115 of the body 114 of the case 110 of the energy cell 100 is cleaved by rotating the energy cell securement device 820 under the cutting tool 832.

In one embodiment, the end 115 of the body 114 of the case 110 of the energy cell 100 is cleaved by repetitively rotating the energy cell securement device 820 under the cutting tool 832 in a reciprocating motion.

The concepts described herein may be employed to disassemble an embodiment of the energy cell 100 described with reference to FIGS. 1A and 1B.

The concepts facilitate and enable battery disassembly without the use of high-speed cutting tools.

The concepts facilitate and enable battery disassembly in an environmentally controlled space, e.g., under a hooded area or in a glove box.

The concepts facilitate and enable battery disassembly that generates minimal debris.

The concepts facilitate and enable battery disassembly that may be electrically or pneumatically operated.

The concepts facilitate and enable battery disassembly that may be manually controlled.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

The term “controller” may include a personal computer, tablet, cellular phone, or other device capable of one or more of the following functions: interfacing with a user via audible voice, hand gesturing, or other means; capturing information from one or more sensors, compiling and/or analyzing information; controlling one or multiple actuators; and communicating with other devices.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which may be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A system for disassembling a case of an energy storage device (energy cell), the system comprising:
a energy cell securement device arranged on a carriage; and
a cutting tool;
wherein the energy cell securement device is configured to fixedly secure a energy cell with a portion of a case of the energy cell being exposed;
wherein the energy cell securement device and the cutting tool are arranged such that the portion of the case is able to contact the cutting tool; and
wherein the carriage is configured to convey the energy cell securement device in relation to the cutting tool such that the cutting tool is positioned to cleave the portion of the case of the energy cell.

2. The system of claim 1, wherein the carriage is configured to convey the energy cell securement device such that the cutting tool is positioned to cleave the portion of the case of the energy cell without interfering with an internal portion of the energy cell.

3. The system of claim 1, wherein the carriage is configured to translate the energy cell securement device such that the cutting tool is positioned to cleave a longitudinal slit into the case of the energy cell.

4. The system of claim 1, wherein the carriage is arranged on a table, wherein the table includes a base and a worm gear, and wherein the carriage is translatable on the base to translate the energy cell securement device in response to a rotation of the worm gear.

5. The system of claim 4, wherein the carriage is translatable on the base to translate the energy cell securement device in response to the rotation of the worm gear such that the cutting tool is positioned to cleave a longitudinal slit in the portion of the case of the energy cell.

6. The system of claim 1, wherein the carriage is arranged on a table, wherein the table includes a base and a worm gear, and wherein the carriage is rotatable on the base to rotate the energy cell securement device in response to a rotation of the worm gear.

7. The system of claim 6, wherein the carriage is rotatable on the base to rotate the energy cell securement device in response to the rotation of the worm gear such that the cutting tool is positioned to cleave a peripheral slit in the portion of the case of the energy cell.

8. The system of claim 7, wherein the case is cylindrically shaped including a first end; and
wherein the table is configured to rotate the energy cell securement device such that the cutting tool is positioned to cleave the peripheral slit in the case of the energy cell proximal to the first end.

9. The system of claim 1, wherein the cutting tool comprises a wedge-shaped chisel.

10. The system of claim 1, wherein the cutting tool comprises a snipping tool.

11. The system of claim 1, wherein the cutting tool is a fixed saw blade.

12. The system of claim 1, wherein the energy cell securement device comprises a clamping vise.

13. The system of claim 12, wherein the clamping vise includes opposed moveable jaws, wherein faces of the opposed moveable jaws are semi-cylindrically shaped.

14. A method for disassembling a energy cell having a case, the method comprising:
securing, via a energy cell securement device, the energy cell to a moveable table, wherein a portion of the case is exposed; and
moving a portion of the moveable table proximal to a cutting tool such that the case of the energy cell interferes with the cutting tool;
wherein the moveable table is configured to convey the energy cell securement device such that the cutting tool cleaves the portion of the case.

15. The method of claim 14, wherein moving a portion of the moveable table proximal to a cutting tool comprises translating the portion of the moveable table such that the case of the energy cell is cleaved by the cutting tool along a longitudinal axis of the case.

16. The method of claim 15, comprising cutting, via the cutting tool, a slit in the portion of the case along the longitudinal axis of the case.

17. The method of claim 14, wherein moving a portion of the moveable table proximal to a cutting tool comprises rotating the portion of the moveable table such that the case of the energy cell is cleaved by the cutting tool around an outer periphery of the case.

18. The method of claim 17, comprising cutting, via the cutting tool, a slit in the portion of the case around an outer periphery of the case of the energy cell.

19. A system for disassembling a energy cell having a case, comprising:
a energy cell securement device arranged on a table;
the table including a base section, an elevating portion, an elevation carriage, a rotatable carriage, and a rotational actuator; and
a cutting tool;
wherein the energy cell securement device is configured to fixedly secure a energy cell with a portion of a case thereof being exposed;
wherein the cutting tool is arranged to contact the case;
wherein the elevation carriage is arranged to move vertically in relation to the base section to vertically lift the energy cell securement device in response to a lifting action by the elevating portion;
wherein the elevation carriage is configured to convey the energy cell securement device in relation to the cutting tool such that the cutting tool is positioned to cleave a longitudinal slit in the case of the energy cell;
wherein the rotatable carriage is arranged to rotate the energy cell securement device in response to a rotating action from the rotational actuator; and
wherein the rotatable carriage is configured to convey the energy cell securement device in relation to the cutting tool such that the cutting tool is positioned to cleave a peripheral slit in the case of the energy cell.

20. The system of claim 19, wherein the cutting tool comprises a wedge-shaped chisel.
